(19) United States
(12) Patent Application Publication
(10) Pub. No.: US 2010/0117284 A1
(43) Pub. Date: May 13, 2010

(54) SHEET FOLDING APPARATUS, IMAGE FORMING APPARATUS, AND SHEET FOLDING METHOD

(75) Inventor: Hiroyuki TAGUCHI, Shizuoka-Ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/615,891

(22) Filed: Nov. 10, 2009

Related U.S. Application Data
(60) Provisional application No. 61/114,024, filed on Nov. 12, 2008.
(60) Provisional application No. 61/150,259, filed on Feb. 5, 2009.

(51) Int. Cl. B41F 13/56; B65H 5/06; B65H 3/06

(52) U.S. Cl. 270/20.1; 271/264; 271/109

(57) ABSTRACT

A sheet folding apparatus includes: a carrying path through which a printed sheet is carried and which has an exit facing upward; a tray on which the sheet carried through the carrying path is stacked while being vertically sloped; an assist roller which rotates in a manner of pushing the sheet against the tray and pushing the sheet upward on the tray before a rear end of the sheet is discharged from the exit after a forward end of the sheet passes the exit of the carrying path, and which rotates in a reverse direction in a manner of pushing the sheet downward on the tray after the rear end of the sheet is discharged from the exit; and a stacker which is provided below the tray and receives and supports the rear end of the sheet pushed down by the assist roller.

### CROSS-REFERENCE TO RELATED APPLICATIONS

This application is based upon and claims the benefit of priority from: U.S. provisional applications 61/114,024 filed on Nov. 12, 2008, and 61/150,259 filed on Feb. 5, 2009, the entire contents of each of which are incorporated herein by reference.

### TECHNICAL FIELD

The present invention relates to a sheet folding apparatus, an image forming apparatus, and a sheet folding method, and particularly to a sheet folding apparatus, an image forming apparatus, and a sheet folding method for stitching and folding a printed sheet.

### BACKGROUND

There is a sheet finisher which is installed downstream from an image forming apparatus such as a copier, printer or multi-function peripheral (MFP) and carries out finishing such as punching and stitching of printed sheets.

Recently, sheet finishers have more diverse functions. There is a sheet folding apparatus having a folding function to fold a part of a sheet and a saddle stitching and middle-folding function to stitch the middle of a sheet with staples and then fold the sheet in the middle, in addition to the punching and stitching functions (see JP-A-6-266182).

The sheet folding apparatus having the saddle stitching and middle-folding function is capable to produce a booklet from plural printed sheets (bookbinding).

The sheet folding apparatus stacks printed sheets on a sloped tray called stack tray. After the middle of the sheets is stitched with staples or the like, a pair of rollers called fold rollers forms a fold at the stitched part.

A sheet printed by an image forming apparatus passes through a carrying path having an exit facing upward, and is discharged to the stack tray. The sheet discharged from the carrying path moves up in a free state toward the upper side of the slope of the stack tray. Then, the sheet falls by its own weight along the slope of the stack tray.

There is a roller called assist roller ahead of the exit of the carrying path. When a sheet is to be sent out to the stack tray, the assist roller is located at a position (first position) where the assist roller does not prevent the sheet from being sent out. When the sheet is completely sent out to the stack tray, the assist roller moves to a position (second position) where the assist roller is abutted against the sent-out sheet. The assist roller rotates in a direction of moving the sheet on the stack tray downward and guides the downward movement of the sheet.

A stacker having a stack pawl stands by below the stack tray. The stacker receives the lower end of the sheet pushed down from the upper side of the slope of the stack tray by the assist roller.

When a subsequent sheet is to be sent out to the stack tray, the assist roller returns to the position where the assist roller does not prevent the sheet from being sent out. The assist roller reciprocates between the first position and the second position, for example, by the tensile force of a solenoid and the restoring force of a spring coil. The assist roller pushes the sheet down and thereby pushes the rear end of the sheet against the stacker. Thus, the sheet is longitudinally aligned.

In order to improve the speed of booklet production, it is necessary to increase the carrying speed of a sheet moving through the carrying path. However, in the conventional sheet folding apparatus, if a sheet is discharged at a high speed from the carrying path, the sheet may fly out significantly upward at the time of discharge and then collide with another unit situated above the stack tray.

If the sheet collides with another unit, inconvenience occurs such as damage to the sheet and generation of unwanted collision noise. To avoid such inconvenience, a dedicated carrying path to guide the sheet which flies out of an exit of the carrying path must be provided, or a separate member to protect the end of the sheet must be provided, causing reduction in spatial use efficiency and increase in cost.

Also, since a sheet discharged from the exit of the carrying path is in a completely free state until guidance by the assist roller starts, there is a high probability that the direction of the sheet is shifted from an upright position and becomes skewed.

### SUMMARY

In view of the above circumstances, it is an object of the invention to provide a sheet folding apparatus, an image forming apparatus, and a sheet folding method in which unwanted flying-out of a sheet can be restrained when the sheet is discharged from the carrying path to the stack tray, and in which the sheet stacked on the stack tray can be prevented from being skewed.

An aspect of the disclosure is a sheet folding apparatus including: a carrying path through which a printed sheet is carried and which has an exit facing upward; a tray on which the sheet carried through the carrying path is stacked while being vertically sloped; an assist roller which rotates in a manner of pushing the sheet against the tray and pushing the sheet upward on the tray before a rear end of the sheet is discharged from the exit after a forward end of the sheet passes the exit of the carrying path, and which rotates in a reverse direction in a manner of pushing the sheet downward on the tray after the rear end of the sheet is discharged from the exit; and a stacker which is provided below the tray and receives and supports the rear end of the sheet pushed down by the assist roller.

Another aspect of the disclosure is an image forming apparatus including: an image forming unit which prints image data on a sheet; a carrying path through which the sheet that is printed is carried and which has an exit facing upward; a tray on which the sheet carried through the carrying path is stacked while being vertically sloped; an assist roller which rotates in a manner of pushing the sheet against the tray and pushing the sheet upward on the tray before a rear end of the sheet is discharged from the exit after a forward end of the sheet passes the exit of the carrying path, and which rotates in a reverse direction in a manner of pushing the sheet downward on the tray after the rear end of the sheet is discharged from the exit; and a stacker which is provided below the tray and receives and supports the rear end of the sheet pushed down by the assist roller.

Still another aspect of the disclosure is a sheet folding method including: carrying a printed sheet through a carrying path having an exit facing upward; pushing the sheet against a vertically sloped tray by an assist roller and pushing the sheet upward on the tray by rotation of the assist roller before a rear end of the sheet is discharged from the exit after a forward end of the sheet passes the exit of the carrying path; rotating the assist roller in a reverse direction and thus pushing the sheet downward on the tray after the rear end of the sheet is discharged from the exit; receiving and supporting the rear end of the sheet pushed down by the assist roller, by a stacker provided below the tray; and pushing a middle part of a plurality of the sheets stacked in the tray and having their rear ends received by the stacker, into a nip of a folding roller pair by a folding blade, and thus forming a fold thereon.

### DESCRIPTION OF THE DRAWINGS

In the attached drawings,

FIG. 1 is a perspective view showing an exemplary appearance of an image forming apparatus;

FIG. 2 is a sectional view showing an exemplary configuration of the image forming apparatus;

FIG. 3 is a sectional view showing an exemplary configuration of a sheet folding apparatus;

FIG. 4 is an enlarged sectional view showing a part of the sheet folding apparatus;

FIG. 5 is a sectional view particularly showing an assist roller and an exemplary roller driving system in a carrying path, of the configuration of the sheet folding apparatus;

FIG. 6 is a perspective view particularly showing the assist roller and the exemplary roller driving system in the carrying path, of the configuration of the sheet folding apparatus;

FIG. 7 is a flowchart showing an example of processing until a sheet is stacked on a stacker after exiting the carrying path;

FIG. 8A to FIG. 8C and FIG. 9A to FIG. 9C are conceptual views of operation for explaining the movement of the assist roller;

FIG. 10 is a functional block diagram showing an exemplary configuration of a driving system of a solenoid;

FIG. 11A to FIG. 11C show a conventional example of a driving control sequence of a solenoid; and

FIG. 12A to FIG. 12D show exemplary driving control sequences of a solenoid according to the embodiment.

### DETAILED DESCRIPTION

An embodiment of a sheet folding apparatus, an image forming apparatus, and a sheet folding method will be described with reference to the attached drawings.

### (1) Configuration of Image Forming Apparatus and Sheet Folding Apparatus

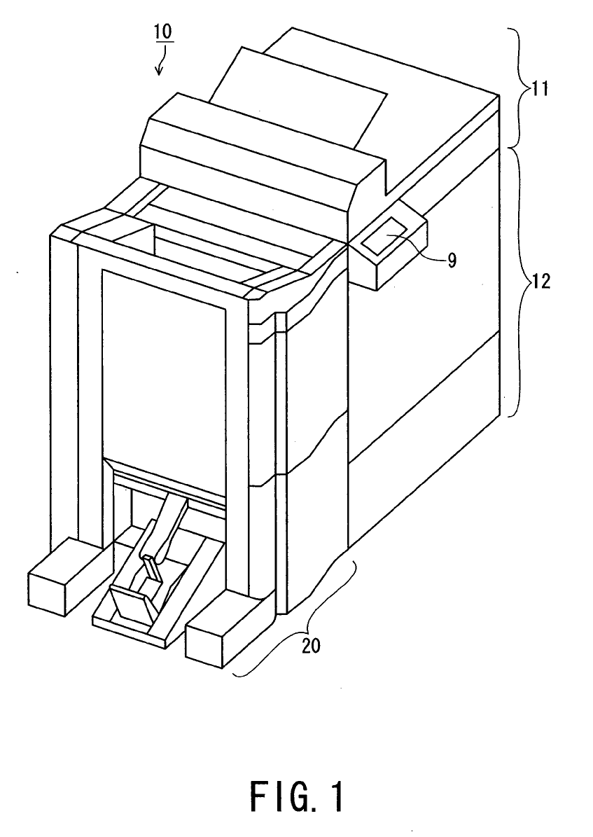

FIG. 1 is a perspective view of appearance showing a basic exemplary configuration of an image forming apparatus 10 according to the embodiment. The image forming apparatus 10 has a scanning unit 11 which scans an original, an image forming unit 12 which electrographically prints image data of the scanned original onto a sheet, a sheet finisher 20 which performs finishing such as sorting, punching, folding, and saddle stitching of the printed sheet, and so on. The image forming unit 12 has an operation unit 9 for a user to carry out various operations.

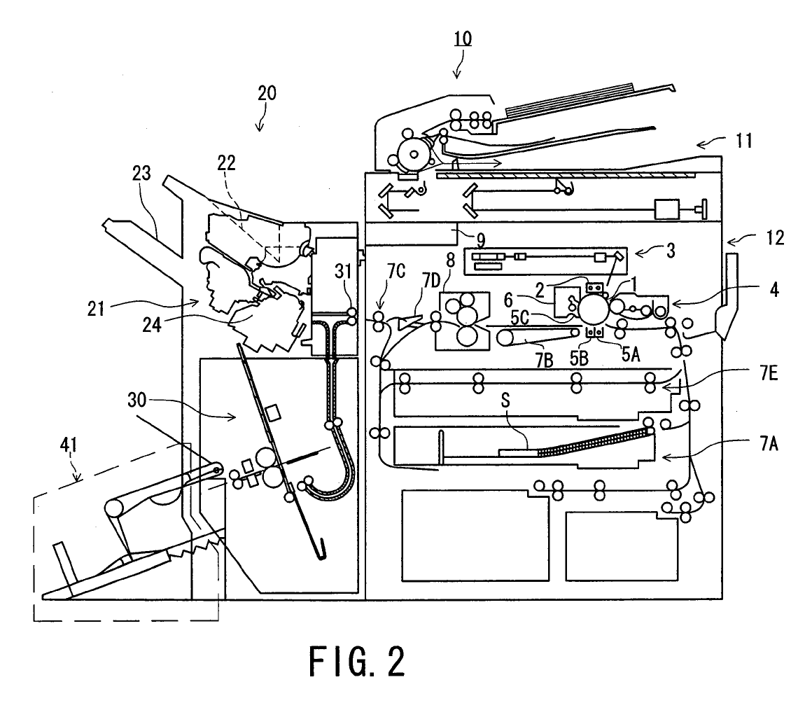

FIG. 2 is a sectional view showing an exemplary configuration of details of the image forming apparatus 10.

The image forming unit 12 of the image forming apparatus 10 has a photoconductive drum 1. Around the photoconductive drum 1, there is a charging unit 2, an exposure unit 3, a developing unit 4, a transfer unit 5A, a neutralizing unit 5B, a separation pawl 5C, and a cleaning unit 6. A fixing unit 8 is provided downstream from the neutralizing unit 5B. These units carry out image formation substantially according to the following procedures.

The charging unit 2 uniformly charges the surface of the photoconductive drum 1. The scanning unit 11 converts a scanned original to image data and outputs the image data to the exposure unit 3. The exposure unit 3 irradiates the photoconductive drum 1 with a laser beam of an intensity corresponding to the level of the image data, and thus forms an electrostatic latent image on the photoconductive drum 1. The developing unit 4 develops the electrostatic latent image with toner and forms a toner image on the photoconductive drum 1.

A sheet housing unit 7A houses sheets. Several carrying rollers carry a sheet from the sheet housing unit 7A to a transfer position (a gap between the photoconductive drum 1 and the transfer unit 5A). At the transfer position, the transfer unit 5A transfers the toner image on the photoconductive drum 1 to a photoconductive sheet. The neutralizing unit 5B eliminates electric charges on the surface of the sheet to which the toner image is transferred. The separation pawl 5C separates the sheet from the photoconductive drum 1. An intermediate transfer unit 7B carries the separated sheet to the fixing unit 8. The fixing unit 8 heats and pressurizes the sheet and thus fixes the toner image on the sheet. A discharge unit 7C outputs the sheet, on which fixing is finished, to the sheet finisher 20.

The cleaning unit 6 located downstream from the separation pawl 5C removes the developer remaining on the surface of the photoconductive drum 1 and prepares for next image formation.

In the case of double-side printing, the sheet having the toner image fixed to its surface is diverted from the ordinary discharge path by a carrying path switching plate 7D. The sheet is then switched back and reversed in a reverse carrying unit 7E. Printing similar to one-side printing is carried out on the back side of the reversed sheet. The sheet is then outputted from the discharge unit 7C to the sheet finisher 20.

The sheet finisher 20 has a finishing unit 21, a sheet folding apparatus 30, a sheet bundle placing unit 41 and so on.

The finishing unit 21 carries out processing to discharge a printed sheet to a fixed tray 22 or a movable tray 23, and processing to stitch an edge of a sheet bundle by a staple unit 24.

The sheet folding apparatus 30 is located below the finishing unit 21. The sheet folding apparatus 30 stitches the middle of plural printed sheets with staples, folds the part stitched with staples in the middle, and thus produces a booklet (saddle stitching).

The booklet that is saddled-stitched by the sheet folding apparatus 30 is outputted to the sheet bundle placing unit 41. The bound booklet is ultimately placed in the sheet bundle placing unit 41.

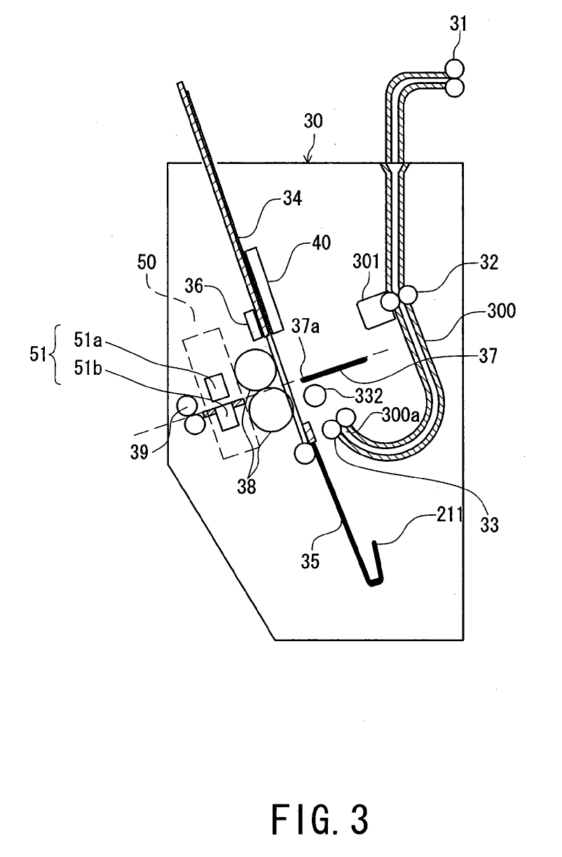

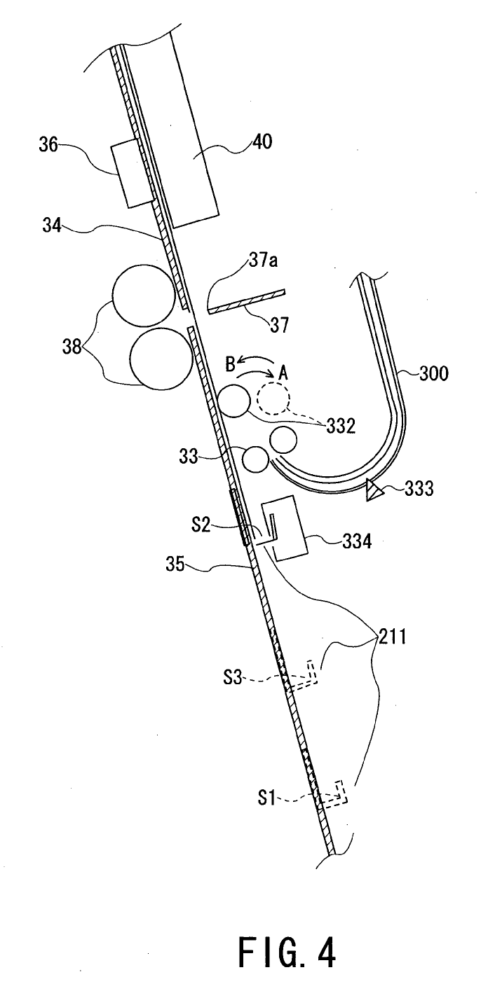

FIG. 3 is a sectional view showing an exemplary configuration of details of the sheet folding apparatus 30. FIG. 4 is an enlarged sectional view showing a part of the sheet folding apparatus 30.

An entrance roller pair 31 provided at the entrance of the sheet finisher 20 receives the printed sheet discharged from the discharge unit 7C of the image forming unit 12 and delivers the sheet to an intermediate roller pair 32. The intermediate roller pair 32 delivers the sheet to an exit roller pair 33. The exit roller pair 33 sends out the sheet to a stack tray 34 having a sloped placing surface.

The path of the sheet from the entrance roller pair 31 to the exit roller pair 33 is hereinafter called carrying path 300 for sheet. An exit 300a of the carrying path 300 faces upward. The forward end of the sheet discharged from the exit 300a heads upward on the slope of the stack tray 34.

An assist roller 332 is provided ahead of the exit roller pair 33. The operation and action of the assist roller 332 will be described later.

A stacker 35 having a stack pawl 211 stands by below the stack tray 34. The stacker 35 receives the lower end of the sheet sent from the carrying path 300 and the sheet is stacked sequentially.

The assist roller 332 pushes down the sheet toward the stacker 35 to align the sheet longitudinally. When the number of sheets reaches to a prescribed number designated by the operation unit 9, a lateral alignment unit 40 carries out lateral alignment of the sheets.

A stapler (saddle stitching unit) 36 is provided at an intermediate part of the stack tray 34. When the stack tray 34 receives a sheet, the position of the stack tray 34 rises from a standby position S1 to a sheet receiving position S2, as shown in FIG. 4. The sheet receiving position S2 is adjusted so that the position on the sheet bundle to be stapled (the middle in vertical direction of the sheet bundle) faces the stapler 36.

As the sheet bundle is saddle-stitched by the stapler 36, the stacker 35 moves down until the position on the sheet bundle where a fold should be formed (the position that is the middle in the vertical direction of the sheet bundle and is stapled) comes in front of a folding blade 37 (folding position S3 in FIG. 4).

As the position where a fold should be formed comes in front of the folding blade 37, a forward end 37a of the folding blade 37 pushes in the surface that should be the inner surface after the sheet bundle is folded.

A folding roller pair 38 is provided ahead in the direction of movement of the folding blade 37. The nip of the folding roller pair 38 drags in the sheet bundle that is pushed in by the folding blade 37. Thus, a fold is formed in the middle of the sheet bundle.

After forming the fold on the sheet bundle, the folding roller pair 38 carries the sheet bundle to a fold reinforcing unit 50 (see FIG. 3) on the downstream side.

The fold reinforcing unit 50 has a fold reinforcing roller pair 51 (an upper roller (second roller) 51a and a lower roller (first roller) 51b). When the folding roller pair 38 carries the sheet bundle to the position where the fold on the sheet bundle faces the fold reinforcing roller pair 51, the folding roller pair 38 stops rotating and temporarily stops carrying the sheet bundle.

The fold reinforcing roller pair 51 moves in a direction orthogonal to the carrying direction of the sheet bundle (direction along the fold line) while pressurizing the fold. The fold is thus reinforced.

After the fold is reinforced by the fold reinforcing unit 50, the folding roller pair 38 resumes rotation and carries the sheet bundle toward a discharge roller pair 39. The discharge roller pair 39 sends out the sheet bundle to the sheet bundle placing unit 41. The sheet bundle placing unit 41 stacks the saddle-stitched sheet bundle (booklet).

### (2) Operation of Assist Roller

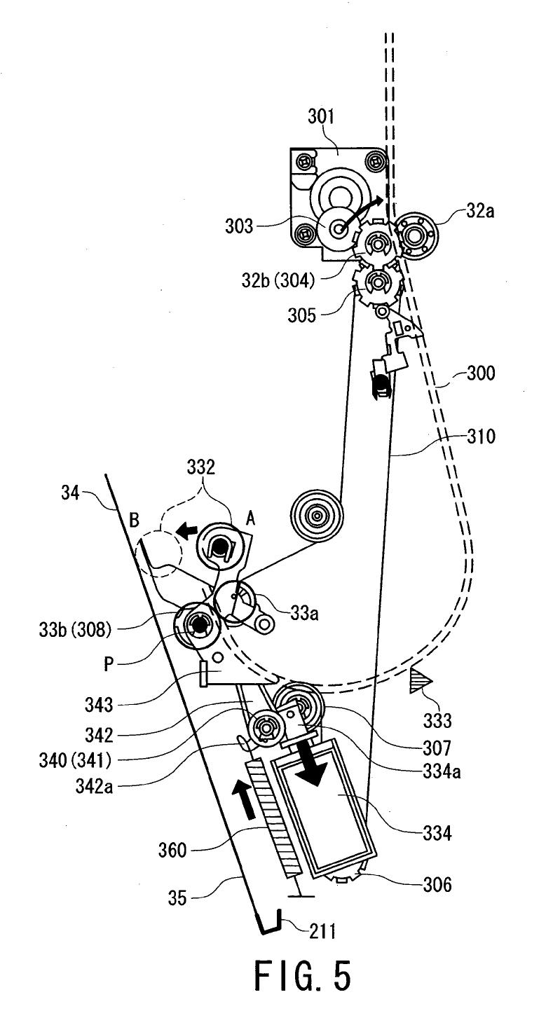

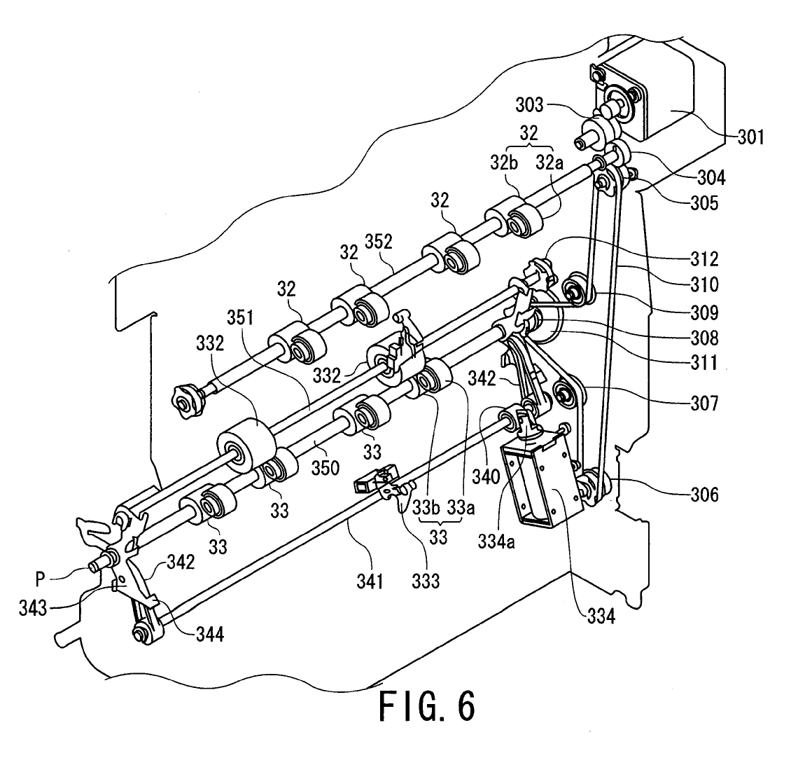

FIG. 5 and FIG. 6 show an exemplary configuration of a driving system of the assist roller 332, the intermediate roller pair 32, the exit roller pair 33 and the like.

As shown in FIG. 6, a carrying motor 301 transmits a rotational driving force to an intermediate roller gear 304 via a gear 303. The intermediate roller gear 304 rotates a driving roller 32b of the intermediate roller pair 32 via a shaft 352. The intermediate roller pair 32 is located in an upper part of the carrying path 300 and carries a sheet downward in the carrying path 300 by the rotation of the driving roller 32b and a driven roller 32a. A sheet detection sensor 333 is provided at a halfway part of the carrying path 300.

The intermediate roller gear 304 fits with a gear 305 and transmits the rotational driving force of the carrying motor 301. The rotation of the gear 305 is transmitted to a exit roller gear 308 via a timing belt 310 laid across a gear 306, a tension roller 307, the exit roller gear 308 and a tension roller 309.

The exit roller gear 308 rotates a driving roller 33b of the exit roller pair 33 via a shaft 350. The exit roller pair 33 is located at the exit of the carrying path 300 and pushes out a sheet upward above the carrying path 300 by the rotation of the driving roller 33b and a driven roller 33a.

An intermediate gear 311 that is axially fixed to the shaft 350 is provided ahead of the exit roller gear 308. The intermediate gear 311 fits with an assist roller gear 312. The assist roller gear 312 rotates the assist roller 332 via a shaft 351 in the opposite direction of the driving roller 33b of the exit roller pair 33.

There is a solenoid 334 below the carrying path 300. A plunger 334a of the solenoid 334 engages with a solenoid gear 340 that is axially fixed to a shaft 341. When the solenoid 334 is on, the electromagnetic force of the solenoid 334 pulls the plunger 334a toward the inner side of the solenoid 334. As the plunger 334a is pulled in, the solenoid gear 340 and the shaft 341 rotate clockwise in FIG. 5 and FIG. 6.

As the shaft 341 rotates, when the solenoid 334 is on, first levers 342 at both ends of the shaft 341 rotate clockwise as well.

Meanwhile, second levers 343 are provided at both ends of the shaft 350 that axially fixes the driving roller 33b of the exit roller pair 33. The shaft 350 supports the central part of the second levers 343 so that the second levers 343 pivotally turn about a pivot P. A pawl 344 engaged with the first lever 342 is provided at the lower ends of the second levers 343. The upper ends of the second levers 343 pivotally support the shaft 351 of the assist roller 332.

If the first levers 342 rotate clockwise, the engagement of the pawls 344 causes the second levers 343 to rotate counterclockwise about the pivot P, and also the positions of the shaft 351 and the assist roller 332 rotationally move counterclockwise about the pivot P. Consequently, when the solenoid 334 is on, the assist roller 332 moves from a first position A to a second position B shown in FIG. 5.

An engagement pawl 342a is provided at a proximal part of the first levers 342, as shown in FIG. 5. One end of a spring 360 engages with the engagement pawl 342a. The other end of the spring 360 engages with a frame of the sheet folding apparatus 30.

When the solenoid 334 is turned on, the first levers 342 rotate clockwise as described above and the engagement pawl 342a pulls the spring 360. When the solenoid 334 is turned on from off-state, the assist roller 332 moves from the first position A to the second position B. While the solenoid 334 is on, the assist roller 332 maintains the second position B against the energizing force of the spring 360.

When the solenoid 334 is turned off from on-state, the plunger 334a is released from the electromagnetic force. Consequently, the energizing force of the spring 360 causes the first levers 342 to rotate counterclockwise and the second levers 343 to rotate clockwise. The assist roller 332 returns to the first position A from the second position B.

Thus, the assist roller 332 reciprocates between the first position A and the second position B according to on and off state of the solenoid 334.

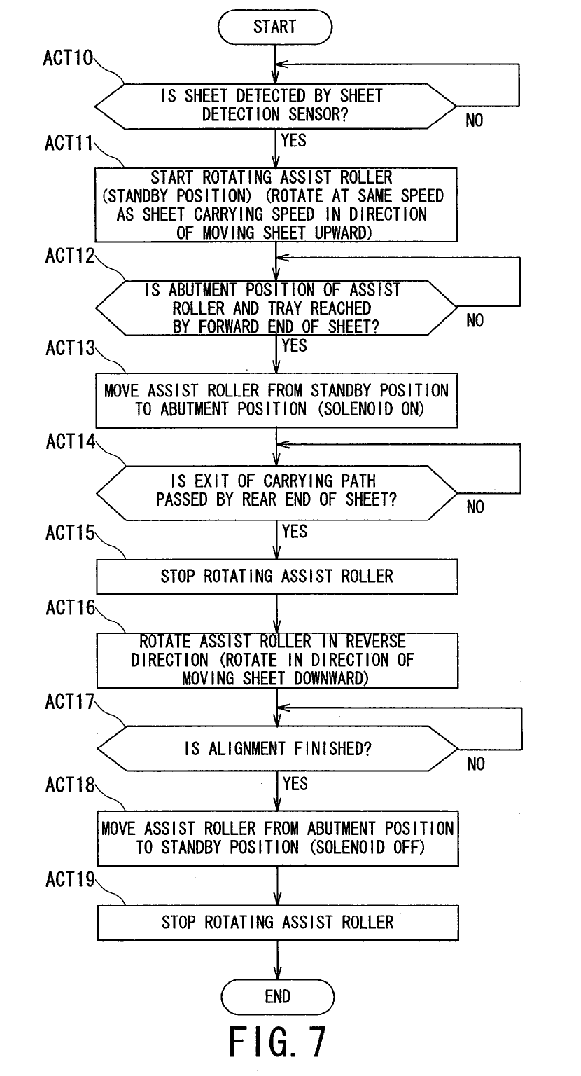

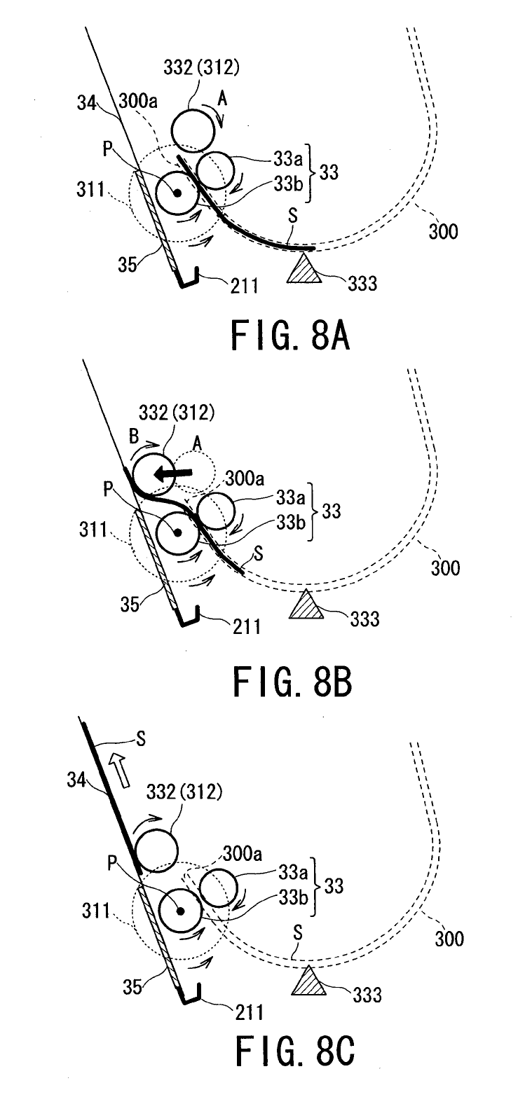

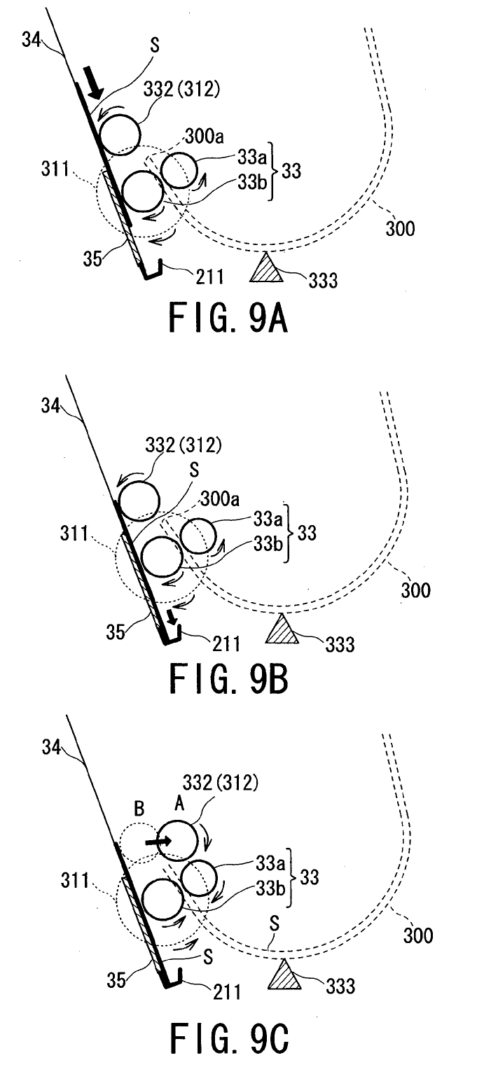

FIG. 7 is a flowchart showing an example of processing until a sheet is stacked on the stacker 35 after exiting the carrying path 300. FIG. 8A to FIG. 8C and FIG. 9A to FIG. 9C are conceptual views of operation for explaining the movement of the assist roller 332 and the like in the processing.

The sheet detection sensor 333 is provided in the carrying path 300 and detects the passage of a sheet S. The sheet detection sensor 333 is, for example, an optical sensor. The sheet detection sensor 333 is a sensor which turns on when the forward end of the sheet S passing through the carrying path 300 is detected and which turns off when the rear end of the sheet S passes.

In ACT 10 of FIG. 7, it is determined whether the sheet S is detected by the sheet detection sensor 333 or not. The part of the sheet S to be detected is not particularly limited at this point. For example, the forward end of the sheet S may be detected.

In ACT 11, the assist roller 332 starts rotating. While the sheet S passes through the carrying path 300, the exit roller pair 33 (the driving roller 33b and the driven roller 33a) rotates in the direction of an arrow shown in FIG. 8A and carries the sheet S toward the exit 300a of the carrying path 300. The driving roller 33b is connected to the intermediate gear 311 at one end of the shaft 350, as shown in FIG. 6. The intermediate gear 311 fits with the assist roller gear 312 which is coaxial with the assist roller 332. Therefore, the assist roller 332 rotates in the opposite direction of the driving roller 33b of the exit roller pair 33 and rotates in the direction of moving the sheet S upward. The diameter of the assist roller 332 is set in such a manner that the upward moving speed of the sheet S becomes the same as the speed of the sheet S moving through the carrying path 300.

In ACT 11, the assist roller 332 starts rotating by the detection of the sheet S by the sheet detection sensor 333. The sheet S may be detected further upstream in the carrying path 300, for example, at the position of the entrance roller pair 31 located at the entrance of the sheet finisher 20, and the assist roller 332 may start synchronously with the start of rotation of the intermediate roller pair 32 and the exit roller pair 33.

When the assist roller 332 starts rotating, the assist roller 332 is located at a standby position where the assist roller 332 does not prevent the sheet S from being discharged from the exit 300a of the carrying path 300, that is, at the first position A in FIG. 5, FIG. 8A and the like.

In ACT 12, it is determined whether or not the forward end of the sheet S reaches an abutment position of the assist roller 332 and the stack tray 34. The position of the forward end of the sheet S can be found from the elapsed time from the time when the sheet detection sensor 333 detects the forward end of the sheet S, and the carrying speed of the sheet S.

Here, the abutment position refers to the position where the outer circumferential surface of the assist roller 332 and the surface of the stack tray 34 are abutted against each other when the assist roller 332 is pivotally turned about the pivot P. When the assist roller 332 is located at the second position shown in FIG. 5, FIG. 8B and the like, the outer circumference of the assist roller 332 and the surface of the stack tray 34 are abutted against each other at the abutment position.

If it is determined in ACT 12 that the forward end of the sheet S reaches the abutment position, the assist roller 332 moves from the standby position (first position A) to the second position B in ACT 13. The assist roller 332 moves by turning on of the solenoid 334 as described before.

When the assist roller 332 moves to the second position B, the rear end of the sheet S is still in the carrying path 300. If the movement of the assist roller 332 is too early, the assist roller 332 may push the forward end of the sheet S, and may push the sheet S back to the direction of the carrying path 300. Thus, with a certain margin period after the forward end of the sheet S reaches to the abutment position, the assist roller 332 may move to the second position.

When the assist roller 332 moves to the second position B, the assist roller 332 rotates in a manner of pushing the sheet S against the stack tray 34 and pushing the sheet S upward on the stack tray 34 (see FIG. 8B).

The assist roller 332 rotates to push the sheet S up along the slope of the stack tray 34 (see FIG. 8C).

In ACT 14, it is determined whether or not the rear end of the sheet S passes through the exit 300a of the carrying path 300. This determination, too, is made according to the elapsed time from the time when the sheet detection sensor 333 detects the forward end of the sheet S.

If it is determined that the rear end of the sheet S passes through the exit 300a, the assist roller 332 stops rotating (ACT 15). Then, the assist roller 332 rotates in the reverse direction, that is, the direction of moving the sheet S downward (ACT 16).

In order to reverse the direction of rotation of the assist roller 332, the direction of rotation of the carrying motor 301 can be reversed and the direction of rotation of the driving roller 33b of the exit roller pair 33 can be reversed. After the rear end of the sheet S passes through the exit 300a, there is no sheet S in the carrying path 300 until the next sheet S is delivered. Therefore, there is no problem with reversing the direction of rotation of the intermediate roller pair 32 and the exit roller pair 33.

As shown in FIG. 9A, with the reversal of the direction of rotation, the assist roller 332 pushes down the sheet S along the slope of the stack tray 34.

To prevent the sheet S from returning back to the carrying path 300, with a predetermined margin period after the rear end of the sheet S passes through the exit 300a of the carrying path 300, the assist roller 332 may stop rotating. With the margin period, the entire sheet S is completely laid on the stack tray 34. Then, the assist roller 332 starts rotating in the reverse direction.

In ACT 17, it is determined whether longitudinal alignment is finished or not, that is, whether or not the rear end of the sheet S slides down to the position where the rear end of the sheet S abuts against the stack pawl 211 of the stacker 35 (see FIG. 9B).

When longitudinal alignment is finished, the solenoid 334 is turned off and the assist roller 332 returns from the abutment position (second position B) to the standby position (first position A) in ACT 18 (see FIG. 9C). Then, the assist roller 332 stops rotating (ACT 19) and prepares for the following sheet S sent into the carrying path 300.

As a prescribed number of sheets are stacked in the stacker 35, the stacked sheet bundle is saddle-stitched or middle-folded to create a booklet.

A conventional assist roller only plays the role of causing the sheet S on the stack tray 34 to move downward. Therefore, the sheet S discharged from the carrying path 300 flies out toward the upper side of the stack tray 34 in a free state without being restricted by the assist roller or the like. As the carrying speed of the sheet S increases, the amount of upward flying of the sheet at the time of discharge increases as well, and the sheet may collide with another unit located above the stack tray 34, for example, the staple unit 24 or the like of the finishing unit 21 shown in FIG. 2. If the sheet collides with another unit, inconvenience occurs such as damage to the sheet and unwanted collision noise.

Since the sheet discharged from the exit of the carrying path is in a completely free state until downward guidance by the assist roller is started, there is a high probability that the direction of the sheet may be shifted from upright and the sheet may be skewed.

In contrast, the sheet folding apparatus 30 and the sheet folding method according to the embodiment employ the following technique. That is, as soon as the forward end of the sheet S exits the exit 300a of the carrying path 300, the assist roller 332 presses the sheet S against the stack tray 34 and pushes up the sheet S toward the upper side of the stack tray 34 by the rotation of the assist roller 332. Further, as the rear end of the sheet S exits the exit 300a of the carrying path 300, the assist roller 332 reverses the direction of the rotation. Then, the assist roller 332 pushes down the sheet S toward the lower side of the stack tray 34 to align the sheet S longitudinally. In the above mentioned technique, the assist roller 332 constantly restricts the sheet S, and thus prevents the sheet S from flying up from the exit 300a of the carrying path 300 and colliding with a unit located above does not occur. Moreover, since the sheet S does not move in the space in a free state, the sheet does not skew, either.

To prevent the sheet S from flying upward or being skewed, a technique of reducing the carrying speed of the sheet S may be employed. However, reducing the carrying speed of the sheet S results in lowering a throughput of booklet production.

In contrast, the sheet folding apparatus 30 and the sheet folding method according to the embodiment, since the upward flying and skewing of the sheet S do not occur, is capable of increasing the carrying speed of the sheet S and improving the throughput of the booklet production.

### (3) Driving Control of Solenoid

As described above, the electromagnetic force of the solenoid 334 and the restoring force of the spring 360 reciprocate the assist roller 332.

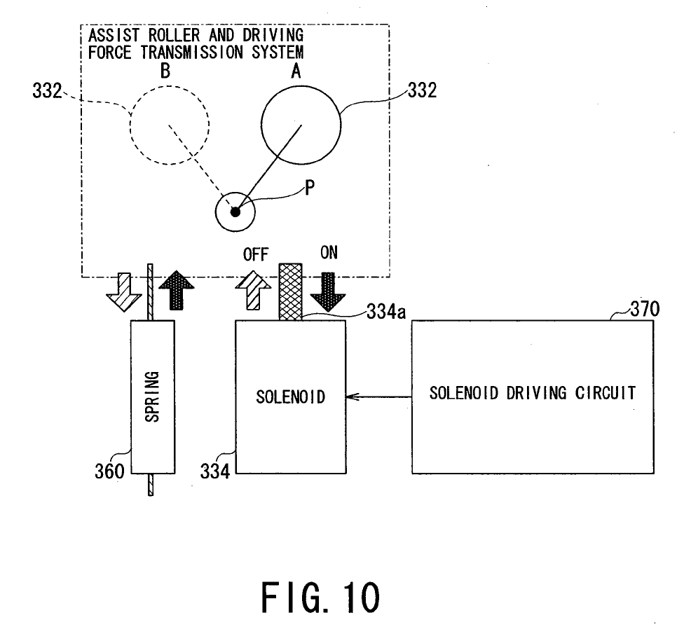

FIG. 10 is a functional block diagram schematically showing the configuration for reciprocation of the assist roller 332. A solenoid driving circuit 370 supplies a driving current to the solenoid 334 and turns the solenoid 334 on and off according to the on and off state of the driving current. When the solenoid 334 is turned on, the solenoid 334 pulls the plunger 334a inward. The pull-in force of the plunger 334a causes the assist roller 332 to move from the first position A to the second position B about the pivot P and pulls the spring 360. When the solenoid 334 is turned off, the restoring force of the spring 360 causes the assist roller 332 to return to the first position A from the second position B and causes the plunger 334a to be pulled out of the solenoid 334.

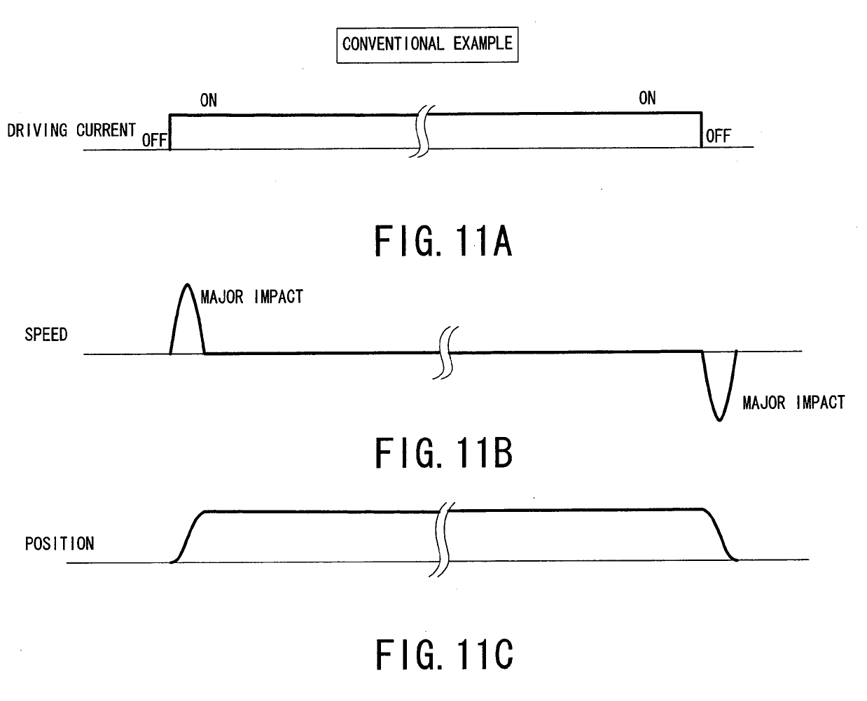

FIG. 11A to FIG. 11C show a conventional example of a driving control sequence of the solenoid 334. FIG. 11A shows on and off state of the driving current of the solenoid 334. FIG. 11B and FIG. 11C show the speed and position, respectively, of the plunger 334a and mechanical components interlocked with the movement of the plunger 334a according to on and off state of the driving current.

In the conventional driving control of the solenoid 334, a shift from off-state to on-state or a shift from on-state to off-state is carried out stepwise. Therefore, the moving speed of the plunger 334a or the like is very high as shown in FIG. 11B and rough and loud impact noise occurs when the solenoid 334 shifts from off-state to on-state or shifts from on-state to off-state.

In the sheet folding apparatus 30 according to the embodiment, in order to restrain the occurrence of such impact noise, a buffer period is provided when the solenoid 334 shifts from off-state to on-state or shifts from on-state to off-state. In the buffer period, the driving current of the solenoid 334 is chopped.

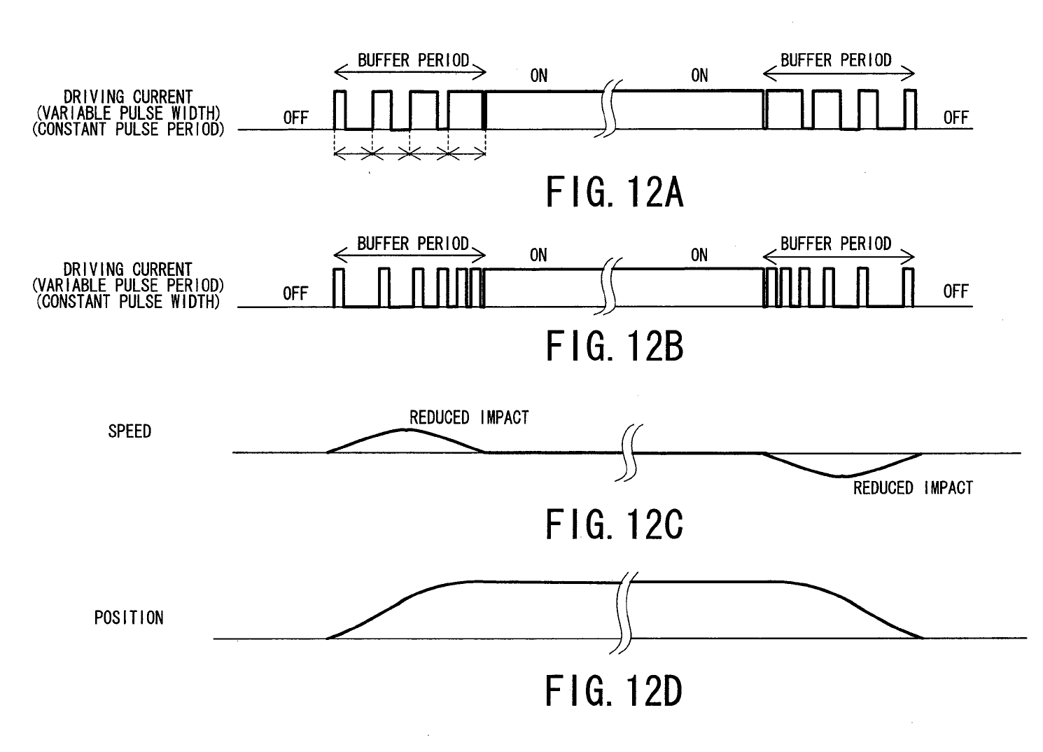

FIG. 12A to FIG. 12D show exemplary driving control sequences of the solenoid 334 according to the embodiment.

FIG. 12A shows an example in which a pulse-like driving current with a constant pulse period is used as a driving current in buffer periods and in which the pulse width is gradually increased during a buffer period when a shift from off-state to on-state is made, whereas the pulse width is gradually decreased during a buffer period when a shift from on-state to off-state is made.

FIG. 12B shows an example in which a pulse-like driving current with a constant pulse width is used as a driving current in buffer periods and in which the pulse period is gradually shortened during a buffer period when a shift from off-state to on-state is made, whereas the pulse period is gradually lengthened during a buffer period when a shift from on-state to off-state is made.

In either method of FIG. 12A or FIG. 12B, during the buffer period from off-state to on-state, the average driving current slowly increases as the duty factor of the pulse increases. On the other hand, during the buffer period from on-state to off-state, the average driving current slowly decreases as the duty factor decreases.

Consequently, the moving speed of the plunger or the like is lower than in the conventional example, as shown in FIG. 12C, and impact noise can be reduced.

FIG. 12A to FIG. 12D show examples in which a buffer period is provided both in shifting from off-state to on-state and in shifting from on-state to off-state is made. However, it is also possible to provide a buffer period in one of the shifting.

The above technique enables reduction in impact noise of the solenoid 334 with an extremely simple method.

As described above, according to the sheet folding apparatus 30, the image forming apparatus 10, and the sheet folding method according to the embodiment, unwanted flying of a sheet can be restrained when the sheet is discharged to the stack tray from the carrying path, and the sheet stacked on the stack tray can be prevented from being skewed. Also, impact noise of the solenoid 334 can be reduced with a simple method.

Embodiments of the invention are not limited to the above embodiments themselves and components can be modified in implementation stages without departing from the scope of the invention. Also, various embodiments can be realized by combinations of plural components disclosed in the above embodiments. For example, some components of all the components in each embodiment may be deleted. Components across different embodiments may be combined.

What is claimed is:

1. A sheet folding apparatus comprising:
a carrying path through which a printed sheet is carried and which has an exit facing upward;
a tray on which the sheet carried through the carrying path is stacked while being vertically sloped;
an assist roller which rotates in a manner of pushing the sheet against the tray and pushing the sheet upward on the tray before a rear end of the sheet is discharged from the exit after a forward end of the sheet passes the exit of the carrying path, and which rotates in a reverse direction in a manner of pushing the sheet downward on the tray after the rear end of the sheet is discharged from the exit; and
a stacker which is provided below the tray and receives and supports the rear end of the sheet pushed down by the assist roller.

2. The apparatus according to claim 1, wherein the assist roller pushes the sheet upward on the tray at the same speed as a speed at which the sheet moves through the carrying path.

3. The apparatus according to claim 1, wherein the assist roller rotates in the manner of pushing the sheet against the tray and pushing the sheet upward on the tray with a margin period after the forward end of the sheet passes the exit of the carrying path.

4. The apparatus according to claim 1, wherein the assist roller rotates in the reverse direction in the manner of pushing the sheet downward on the tray with a margin period after the rear end of the sheet is discharged from the exit.

5. The apparatus according to claim 1, wherein the assist roller is located at a first position where the assist roller does not prevent the sheet from being discharged from the exit before the forward end of the sheet passes the exit of the carrying path,
the assist roller moves to a second position where the assist roller pushes the sheet against the tray during a period until the rear end of the sheet is discharged from the exit after the forward end of the sheet passes the exit of the carrying path, and
the assist roller returns to the first position from the second position after pushing down the sheet until the rear end of the sheet is received by the stacker.

6. The apparatus according to claim 5, further comprising a solenoid and a spring which move the position of the assist roller,
wherein the assist roller is moved from the first position to the second position by a driving force of the solenoid, and
the assist roller is returned to the first position from the second position by a restoring force of the spring.

7. The apparatus according to claim 1, further comprising a folding roller pair and a folding blade which form a fold on a sheet bundle,
wherein the folding blade forms a fold by pushing a middle part of a plurality of the sheets which are stacked on the tray and which have the rear ends received by the stacker, into a nip of the folding roller pair.

8. An image forming apparatus comprising:
an image forming unit which prints image data on a sheet;
a carrying path through which the sheet that is printed is carried and which has an exit facing upward;
a tray on which the sheet carried through the carrying path is stacked while being vertically sloped;
an assist roller which rotates in a manner of pushing the sheet against the tray and pushing the sheet upward on the tray before a rear end of the sheet is discharged from the exit after a forward end of the sheet passes the exit of the carrying path, and which rotates in a reverse direction in a manner of pushing the sheet downward on the tray after the rear end of the sheet is discharged from the exit; and
a stacker which is provided below the tray and receives and supports the rear end of the sheet pushed down by the assist roller.

9. The apparatus according to claim 8, wherein the assist roller pushes the sheet upward on the tray at the same speed as a speed at which the sheet moves through the carrying path.

10. The apparatus according to claim 8, wherein the assist roller rotates in the manner of pushing the sheet against the tray and pushing the sheet upward on the tray with a margin period after the forward end of the sheet passes the exit of the carrying path.

11. The apparatus according to claim 8, wherein the assist roller rotates in the reverse direction in the manner of pushing the sheet downward on the tray with a margin period after the rear end of the sheet is discharged from the exit.

12. The apparatus according to claim 8, wherein the assist roller is located at a first position where the assist roller does not prevent the sheet from being discharged from the exit before the forward end of the sheet passes the exit of the carrying path,
the assist roller moves to a second position where the assist roller pushes the sheet against the tray during a period until the rear end of the sheet is discharged from the exit after the forward end of the sheet passes the exit of the carrying path, and
the assist roller returns to the first position from the second position after pushing down the sheet until the rear end of the sheet is received by the stacker.

13. The apparatus according to claim 12, further comprising a solenoid and a spring which move the position of the assist roller,
wherein the assist roller is moved from the first position to the second position by a driving force of the solenoid, and
the assist roller is returned to the first position from the second position by a restoring force of the spring.

14. The apparatus according to claim 8, further comprising a folding roller pair and a folding blade which form a fold on a sheet bundle,
wherein the folding blade forms a fold by pushing a middle part of a plurality of the sheets which are stacked on the tray and which have the rear ends received by the stacker, into a nip of the folding roller pair.

15. A sheet folding method comprising:
carrying a printed sheet through a carrying path having an exit facing upward;
pushing the sheet against a vertically sloped tray by an assist roller and pushing the sheet upward on the tray by rotation of the assist roller before a rear end of the sheet is discharged from the exit after a forward end of the sheet passes the exit of the carrying path;
rotating the assist roller in a reverse direction and thus pushing the sheet downward on the tray after the rear end of the sheet is discharged from the exit;
receiving and supporting the rear end of the sheet pushed down by the assist roller, by a stacker provided below the tray; and
pushing a middle part of a plurality of the sheets stacked in the tray and having the rear ends of the sheets received by the stacker, into a nip of a folding roller pair by a folding blade, and thus forming a fold thereon.

16. The method according to claim 15, wherein the assist roller pushes the sheet upward on the tray at the same speed as a speed at which the sheet moves through the carrying path.

17. The method according to claim 15, wherein the assist roller rotates in a manner of pushing the sheet against the tray and pushing the sheet upward on the tray with a margin period after the forward end of the sheet passes the exit of the carrying path.

18. The method according to claim 15, wherein the assist roller rotates in the reverse direction in a manner of pushing the sheet downward on the tray with a margin period after the rear end of the sheet is discharged from the exit.

19. The method according to claim 15, wherein the assist roller is located at a first position where the assist roller does not prevent the sheet from being discharged from the exit before the forward end of the sheet passes the exit of the carrying path,
the assist roller moves to a second position where the assist roller pushes the sheet against the tray during a period until the rear end of the sheet is discharged from the exit after the forward end of the sheet passes the exit of the carrying path, and
the assist roller returns to the first position from the second position after pushing down the sheet until the rear end of the sheet is received by the stacker.

20. The method according to claim 19, wherein the assist roller is moved from the first position to the second position by a driving force of a solenoid, and
the assist roller is returned to the first position from the second position by a restoring force of a spring.
